(19) United States
(12) Patent Application Publication
(10) Pub. No.: US 2012/0120057 A1
(43) Pub. Date: May 17, 2012

(54) Display Driver Circuit, Operating Method Thereof, and User Device Including the Same

(76) Inventors: Kyung-Sang Cho, Incheon (KR); Gyoocheol Hwang, Seongnam-si (KR); Kyungsuc Nah, Seoul (KR); Woohyun Shim, Seoul (KR)

(21) Appl. No.: 13/236,404

(22) Filed: Sep. 19, 2011

(30) Foreign Application Priority Data
Nov. 17, 2010 (KR) 10-2010-0114543

(51) Int. Cl. G06T 15/00; G09G 5/00

(52) U.S. Cl. 345/419; 345/204

(57) ABSTRACT

A display driver integrated circuit includes a source driver driving source lines of the display panel. A plurality of memory devices stores image data to be displayed by the display panel. A memory controller controls a write operation and a read operation of the plurality of memory devices. A timing controller controls the memory controller such that the image data in the plurality of memory devices is displayed as three-dimensional (3D) image data and controls the source driver such that the generated 3D image data is provided to the display panel.

### CROSS-REFERENCE TO RELATED APPLICATIONS

This application claims priority to Korean Patent Application No. 10-2010-0114543, filed Nov. 17, 2010, the contents of which are herein incorporated by reference in its entirety.

### BACKGROUND

1. Technical Field

The present invention relates generally to a display driver. More particularly, this invention relates to a display driver circuit, an operating method thereof, and a user device including the same.

2. Discussion of the Related Art

User devices such as mobile electronic devices are often designed to be small, light and to consume minimal power. To achieve these design goals, mobile electronic devices may use flat panel display devices such as a liquid crystal displays (LCDs) instead of larger display devices such as cathode-ray tubes (CRTs). Flat panel display devices may include a panel for displaying images. This panel may include a plurality of pixels, which are each formed at intersections of gate lines and source lines. The gate lines are used to select the gates of the pixels and the source lines are used for transferring color data, i.e. gradation data, to each pixel.

Images are displayed on the LCD by applying control signals to the gate lines and color data to source lines. A display driver integrated circuit (DDI) may be used to provide the control signals and color data to the LCD panel. For example, the DDI receives image data from a central processing unit of a system/device and converts the received image data into control signals and color data to be provided to the LCD panel.

With the growing interest in providing display devices that are capable of displaying three-dimensional (3D) images, 3D display devices have been designed for use with mobile electronic devices. Examples of mobile devices that may use 3D displays include portable video game consoles, mobile phones, personal digital assistants (PDAs), tablet computers, portable computers such as laptops and notebooks, and the like. In many of these devices, the central processing unit is responsible for processing the 3D image data.

### SUMMARY

An exemplary embodiment of the present invention provides a dedicated display driver integrated circuit for driving a display panel. The display driver integrated circuit includes a source driver driving source lines of the display panel. Memory devices storing image data are displayed by the display panel. A memory controller controls a write operation and a read operation of the memory devices. A timing controller controls the memory controller and the source driver such that the image data in the plurality of memory devices is generated as three-dimensional (3D) image data. The timing controller also controls the source driver such that the generated 3D image data is provided to the display panel.

An exemplary embodiment of the present intention provides operating method for operating a display driver integrated circuit for driving a display panel. The operating method includes storing image data to be displayed by the display panel in memory devices. The memory devices are read such that the stored image data is generated as 3D image data. The read image data is temporarily stored in a source driver and is generated as the 3D image data. The temporarily stored 3D image data is provided to the display panel.

An exemplary embodiment of the present invention provides a user device including a display panel. A display driver integrated circuit drives the display panel. A central processing unit controls the display driver integrated circuit such that an image is displayed on the display panel. The central processing unit provides the display driver integrated circuit with left-eye image data and right-eye image data constituting a 3D image. The display driver integrated circuit is configured to store the left-eye image data and the right-eye image data in memory devices, to generate 3D image data by alternately utilizing the left-eye image data and the right-eye image data stored in the memory devices, and to provide the generated 3D image data to the display panel.

A display driver integrated circuit of driving a display panel includes a source driver driving one or more source lines of the display panel. A plurality of memory devices store image data to be displayed by the display panel. A memory controller controls a write operation or a read operation of the plurality of memory devices. A timing controller controls the memory controller such that the image data stored in the plurality of memory devices are generated as three-dimensional (3D) image data and controlling the source driver such that the generated 3D image data is provided to the display panel.

A method for operating a display driver integrated circuit for driving a display panel includes storing image data to be displayed by the display panel in a plurality of memory devices that includes at least one left-eye memory device for storing left-eye image data and at least one right-eye memory device for storing right-eye image data. The at least one left-eye memory device is different than the at least one right-eye memory device. Left-eye image data is read from the at least one left-eye memory device of the plurality of memory devices. Right-eye image data is read from the at least one right-eye memory device of the plurality of memory devices. The read left-eye and right-eye image data is temporarily stored in a source driver so that the left-eye image data and the right-eye image data are available for simultaneous display. The temporarily stored 3D image data is provided to the display panel.

An autostereoscopic display device includes a display panel having either a parallax barrier or a lenticular lens in proximity thereto. A gate driver drives a plurality of gate lines of the display panel. A source driver drives a plurality of source lines of the display panel. A memory device stores an image signal to be displayed on the display panel. The memory device includes a left-eye image memory part for storing left-eye image data of the image signal and a right-eye image memory part for storing right-eye image data of the image signal. The left-eye image memory part is different than the right-eye image memory part. The left-eye image memory part includes a plurality of distinct left-eye memory units and the right-eye image memory part includes a plurality of distinct right-eye memory units. The left-eye image data is stored by alternating between each of the plurality of left-eye memory units and the right-eye image data is stored by alternating between each of the plurality of right-eye memory units.

### BRIEF DESCRIPTION OF THE FIGURES

Various other objects, features and aspects of the present invention will be more fully appreciated as the same becomes better understood from the detailed description when considered in connection with the accompanying drawings in which like reference characters may designate like corresponding parts throughout and wherein:

FIG. 1 is a block diagram illustrating a display driver integrated circuit according to an exemplary embodiment of the inventive concept;

FIG. 2 is a diagram illustrating a parallax barrier capable of displaying 3D images according to an exemplary embodiment of the inventive concept;

FIG. 3 is a diagram illustrating a lenticular arrangement capable of displaying 3D images according to an exemplary embodiment of the inventive concept;

FIG. 4 is a diagram illustrating a 3D image data processing operation of a display driver integrated circuit according to an exemplary embodiment of the inventive concept;

FIG. 5 is a diagram illustrating a 3D image data processing operation of a display driver integrated circuit in which 3D images are displayed as 2D images in a power saving mode according to an exemplary embodiment of the inventive concept;

FIG. 6 is a diagram illustrating a 2D image data processing operation of a display driver integrated circuit according to an exemplary embodiment of the inventive concept;

FIG. 7 is a flowchart illustrating an operation of a display driver integrated circuit according to an exemplary embodiment of the inventive concept; and

FIG. 8 is a block diagram illustrating a user device for displaying images via a display panel according to an exemplary embodiment of the inventive concept.

### DETAILED DESCRIPTION OF THE EXEMPLARY EMBODIMENTS

Exemplary embodiments of the present invention will be described below in detail with reference to the accompanying drawings. In the drawings, the size and relative sizes of layers and regions may be exaggerated for clarity. Like numbers may refer to like elements throughout.

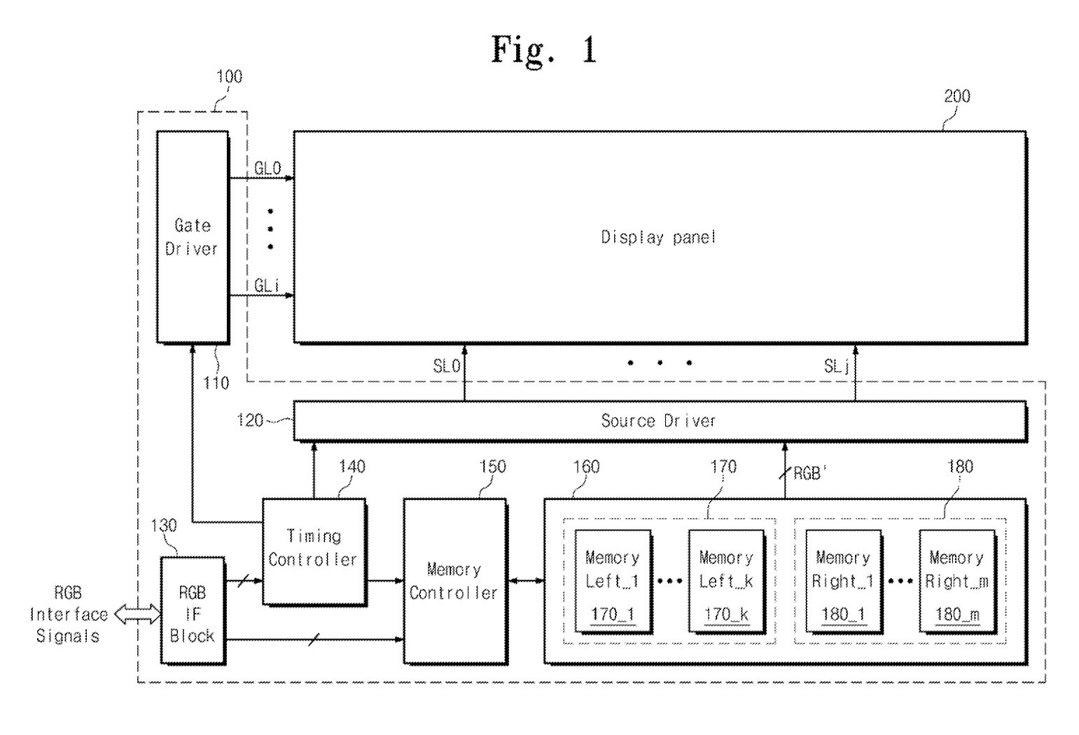

FIG. 1 is a block diagram illustrating a display driver integrated circuit 100 according to an exemplary embodiment of the inventive concept. Referring to FIG. 1, a display driver integrated circuit according to an exemplary embodiment of the inventive concept includes a gate driver 110, a source driver 120, an RGB interface block 130, a timing controller 140, a memory controller 150, and a memory device 160.

The display driver integrated circuit 100 may receive image data from a central processing unit (CPU) of a user device (for example, a mobile electronic device) which displays images via a display panel 200. Hereinafter, the user device displaying images via the display panel 200 may be referred to as a system. The display driver integrated circuit 100 converts received image data into control signals and color data signals and provides the control signals and the color data signals to the display panel 200.

The display panel 200 may include a plurality of pixels (not shown) displaying images. The pixels may be formed at intersections of gate lines GL0 to GLi and source lines SL0 to SLj. Although not illustrated in FIG. 1, each of the pixels may include a switching element connected with corresponding gate and source lines, a liquid crystal capacitor connected with the switching element, and a storage capacitor.

The gate driver 110 drives the gate lines GL0 to GLi according to the control of the timing controller 140. For example, the gate driver 110 sequentially activates the gate lines GL0 to GLi in response to control signals from the timing controller 140. The source driver 120 drives the source lines SL0 to SLj according to the control of the timing controller 140. For example, the source driver 120 operates in response to control signals from the timing controller 140 and drives the source lines SL0 to SLj based on image data RGB′ provided from the memory device 160.

The RGB interface block 130 receives RGB interface signals from the CPU of the system. The RGB interface block 130 transfers the received RGB interface signals to the timing controller 140 and the memory controller 150 according to a signal type.

The RGB interface signals include control signals and image signals. For example, control signals in the RGB interface signals may include a vertical sync signal VSYNC, a horizontal sync signal HSYNC, a data enable signal DE, and the like. Such control signals are sent to the timing controller 140. The timing controller 140 provides respective blocks (for example, the gate driver, the source driver, and the memory controller) with control signals to drive the display panel 200 based on the transferred control signals. For example, the timing controller 140 controls an overall operation of the display driver integrated circuit 100.

Here, the vertical sync signal VSYNC included in the RGB interface signals indicates a time taken to display one frame on the display panel 200. The horizontal sync signal HSYNC included in the RGB interface signals indicates a time taken to drive pixels connected with one gate line of the gate lines GL0 to GLi. Accordingly, the horizontal sync signal HSYNC may be formed of pulses each corresponding to pixels connected with one gate line. The data enable signal DE indicates a time taken to provide image data RGB′ to pixels of the display panel 200.

Image signals included in the RGB interface signals may include color data signals to be displayed via pixels of the display panel 200. The image signals are transferred to the memory controller 150. The memory controller 150 controls the memory device 160 such that image signals transferred according to the control of the timing controller 140 are stored within the memory device 160. The memory controller 150 controls the memory device 160 such that image data RGB′ stored in the memory device 160 according to the control of the timing controller 140 is provided to the source driver 120.

The memory device 160 includes a plurality of memory units. The display driver integrated circuit processes 3D image data. Accordingly, image signals provided to the RGB interface block 130 may include left-eye image data and right-eye image data. The memory device 160 includes a left-eye image memory part 170 for storing left-eye image data and a right-eye image memory part 180 for storing right-eye image data. The left-eye image memory part 170 includes a plurality of memory units 170_1 to 170_k to support an interleaving operation. Likewise, the right-eye image memory part 180 includes a plurality of memory units 180_1 to 180_m to support an interleaving operation.

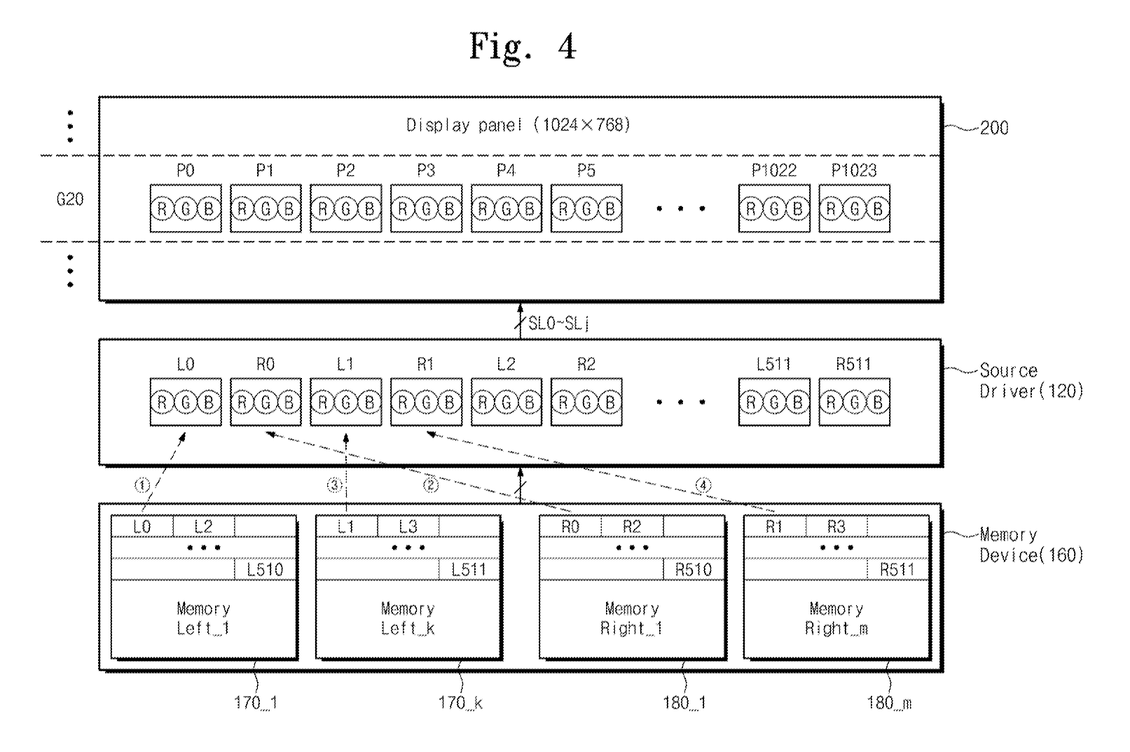

Left-eye image data and right-eye image data constituting 3D image data are divided and stored in the memory units of their respective memory parts. For example, left-eye image data may be stored in the left-eye image memory units 170_1 to 170_k, and right-eye image data may be stored in the right-eye image memory units 180_1 to 180_m. In this case, left-eye and right-eye image data may be stored in an interleaving manner to reduce an access time of the memory device 160. Left-eye image data stored in the left-eye image memory part 170 and right-eye image data stored in the right-eye image memory part 180 may be provided alternately to the source driver 120. Left-eye image data stored in the left-eye image memory part 170 and right-eye image data stored in the right-eye image memory part 180 may be read in an interleaving manner to reduce an access time to the memory device 160. Additional description pertaining to the storage of image data within the memory device 160 in the interleaving manner is found below with reference to FIG. 4.

The display driver integrated circuit 100 receives raw image signals from the CPU of the system. The display driver integrated circuit 100 generates 3D image data using the received image signals and provides the 3D image data to the display panel 200. Computational demand placed upon the CPU of the system in displaying of 3D images may thereby be reduced. Accordingly, an operating speed of the CPU may be increased and system resources may be used more efficiently.

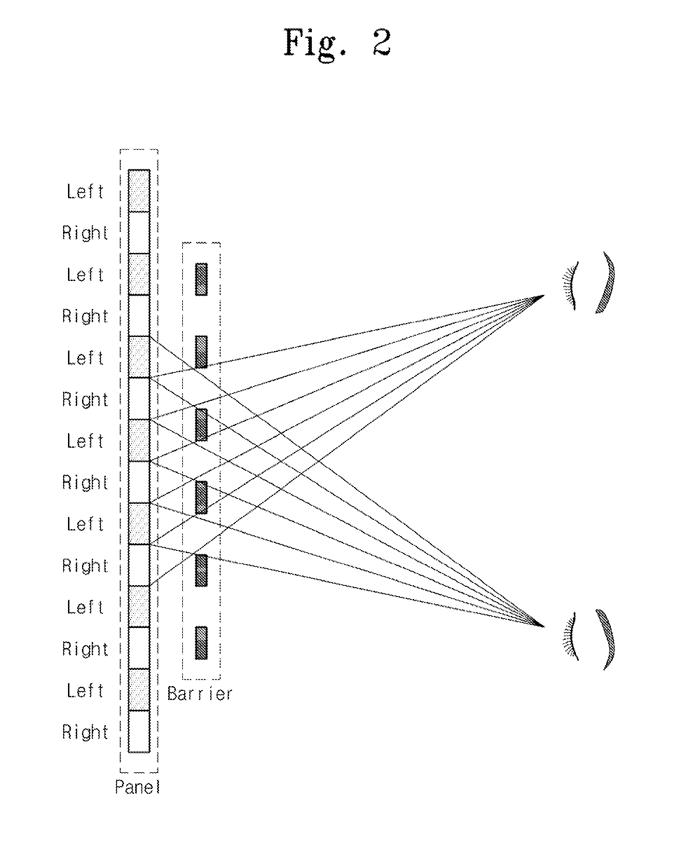

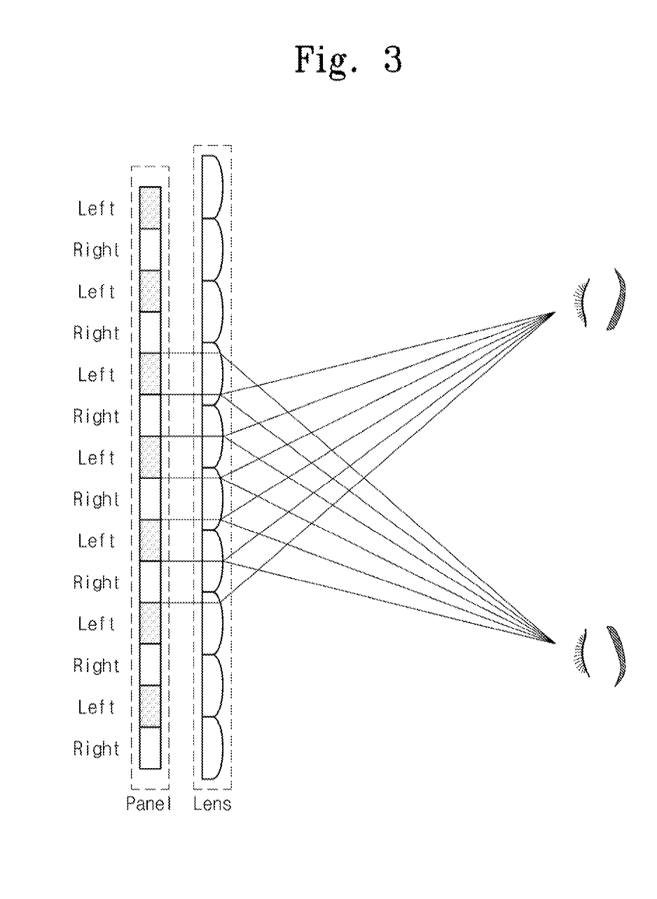

FIG. 2 is a diagram for describing a parallax barrier arrangement capable of displaying 3D images according to an exemplary embodiment of the present invention. FIG. 3 is a diagram for describing a lenticular arrangement capable of displaying 3D images according to an exemplary embodiment of the present invention.

Human left and right eyes are separated by about 65 mm from center to center. Because of this separation, each eye appears to see a close object from a slightly different angle and in a slightly different position. This phenomenon is referred to as binocular disparity and binocular disparity is relied upon by the human brain to infer depth.

Accordingly, a display device may impart upon a human viewer a sense of depth by presenting a left eye and a right eye of the viewer with distinct images that have been processed to provide binocular disparity. Approaches for providing stereoscopic 3D display with or without the use of special 3D glasses utilize arrangements for directing left eye images to a left eye of a viewer and right eye images to a right eye of a viewer. Examples of such approaches that do not utilize 3D glasses include parallax barrier displays and lenticular displays.

The parallax barrier arrangement will be described below with reference to

FIG. 2. A display device having the parallax barrier arrangement simultaneously displays merged images where left-eye images and right-eye images are intermixed in alternating columns displayed on a panel placed behind a barrier of columns. A viewer may see the merged image as a 3D image through openings of the barrier however the barrier may serve to block the left-eye image columns from the viewer's right eye while also blocking the right-eye image columns from the viewer's left eye. The parallax barrier may either be produced by a permanent fixture such as a physical arrangement of columns or a sequence of vertical stripes painted upon a transparent layer or the parallax barrier may be produced by an effect that can be activated and deactivated such as a transparent layer with columns of liquid crystal that can be made to either display the parallax barrier or become fully transparent according to an applied electric field. In the parallax barrier arrangement, if the barrier is controlled (for example, the barrier is controlled to be switched into an off state from an on state), the viewer can see the merged image as a 2D image when the parallax barrier is in an off state. Moreover, the parallax barrier may be embodied as a second liquid crystal panel that is spaced apart from the actual display panel, with the second liquid crystal panel being able to display any desired parallax barrier pattern by sending an appropriately formed control signal thereto. For example, the thickness and spacing of the barrier columns may be controlled.

The lenticular arrangement will be described below with reference to FIG. 3. A display device having the lenticular arrangement displays merged images where left-eye images and right-eye images are disposed in alternating columns on a panel placed behind a lenticular lens. Here, the lenticular lens may be formed of multiple semicircle convex lenses per unit length. A viewer can view the merged image through the lenticular lens as a 3D image. In the lenticular arrangement, if the lenticular lens is controlled, the viewer can see the merged image as a 2D image. For example, the lenticular lens may be negated by inserting a lens or panel having an arrangement of concave lenses over the arrangement of convex lenses so that the effect of the lenticular lens is canceled. According to another example, the surface of the lenticular lens may be elastic and/or fluid and may be temporarily rendered flat by the imposition of a force that may be physical, electrical, magnetic or some combination thereof.

As illustrated in FIGS. 2 and 3, 3D images are displayed using merged images where left-eye images and right-eye images are divided into columns or strips in which every other column is a section of a left-eye image and every other column is a section of a right-eye image. This arrangement may be described herein as “alternating columns” or “disposed in turn” although it should be understood that the columns so described alternate with respect to proximity and not necessarily with respect to time. With the present disclosure, a display driver integrated circuit 100 may perform operations for generating the above-described merged images. For example, the display driver integrated circuit 100 stores left-eye image data and right-eye image data in corresponding memory units. The display driver integrated circuit 100 reads and disposes left-eye image data and right-eye image data in turn to as to be displayed on a display panel 200.

FIG. 4 is a diagram illustrating a 3D image data processing operation of a display driver integrated circuit according to an exemplary embodiment of the inventive concept. Referring to FIG. 4, a display panel 200 have a resolution of, for example, 1024×768 although other resolutions may be used. Further, a memory device 160 may include two left-eye image memory units 170_1 and 170_k and two right-eye image memory units 180_1 and 180_m. However, the number of left-eye image memory units and the number of right-eye image memory units are not limited to the exemplary configurations offered herein and there may be more or less left-eye and right-eye image memory units within the memory device 160.

A central processing unit of a system may provide image signals. The provided image signals may include n-bot data which may include a red value, a green value, and a blue value according to the desired color and brightness for each pixel. The image data may be divided into left-eye image data and right-eye image data. The image data is stored in the memory device 160 according to the control of the memory controller 150. For example, left-eye image data L0 to L511 may be stored in the left-eye image memory units 170_1 and 170_k, and right-eye image data R0 to R511 may be stored in the right-eye image memory units 180_1 and 180_m.

The left-eye image data L0 to L511 may be stored alternately in the left-eye image memory units 170_1 and 170_k to reduce a time taken to store the left-eye image data L0 to L511 in the left-eye image memory units 170_1 and 170_k. For example, the left-eye image data L0 to L511 may be stored in the left-eye image memory units 170_1 and 170_k in an interleaving manner. Likewise, it is well understood that right-eye image data R0 to R511 are stored in right-eye image memory units 180_1 and 180_m in the same manner as the left-eye image data L0 to L511. For example, left-eye image data L0 may be stored in the left-eye image memory 170_1, left-eye image data L1 may be stored in the left eye image memory 170_k, left-eye image data L2 may be stored in the left-eye image memory 170_1, left-eye image data L3 may be stored in the left-eye image memory 170_k, and so on. Where there are more than two image memory units for each eye image, the left-eye image data may be organized accordingly to minimize the likelihood that a delay may occur due to a next image data trying to be stored or read from the memory before a previous image data has completed being stored or read.

The memory controller 150 controls the memory device 160 such that left-eye image data L0 to L511 and right-eye image data R0 to R511 are read in turn. In this case, left-eye image data L0 to L511 and right-eye image data R0 to R511 may be read in an interleaving manner to reduce a time taken to output image data. Left-eye and right-eye image data L0 to L511 and R0 to R511 thus read may be provided to the source driver 120. For example, left-eye and right-eye image data L0 to L511 and R0 to R511 may be provided alternately such that 3D image is displayed on the display panel 200.

As shown in the example illustrated in FIG. 4, left-eye image data L0 is read from the left-eye image memory 170_1 and the read left-eye image data L0 is provided to the source driver 120. Then, right-eye image data R0 is read from the right-eye image memory 180_1 and the read right-eye image data R0 is provided to the source driver 120. Afterwards, left-eye image data L1 is read from the left-eye image memory 170_k and the read left-eye image data L1 is provided to the source driver 120. Then, right-eye image data R1 is read from the right-eye image memory 180_m and the read right-eye image data R1 is provided to the source driver 120. While the above-described image data (left-eye image data or right-eye image data) is being provided to the source driver 120, image data (left-eye image data or right-eye image data) is read out from another memory.

Latches (not shown) of the source driver 120 may temporarily store left-eye and right-eye image data L0 to L511 and R0 to R511 provided to the source driver 120 so as to be disposed in turn. If image data (left-eye image data and right-eye image data) are received by the pixels connected with one gate line in the display panel 200, the source driver 120 provides the stored image data to the display panel 200 through source lines SL0 to SLj under the control of the timing controller 140. Since in the illustrated example 1024 pixels are connected with one gate G20, 1024 image data (512 left-eye image data and 512 right-eye image data) may be provided to the display panel 200.

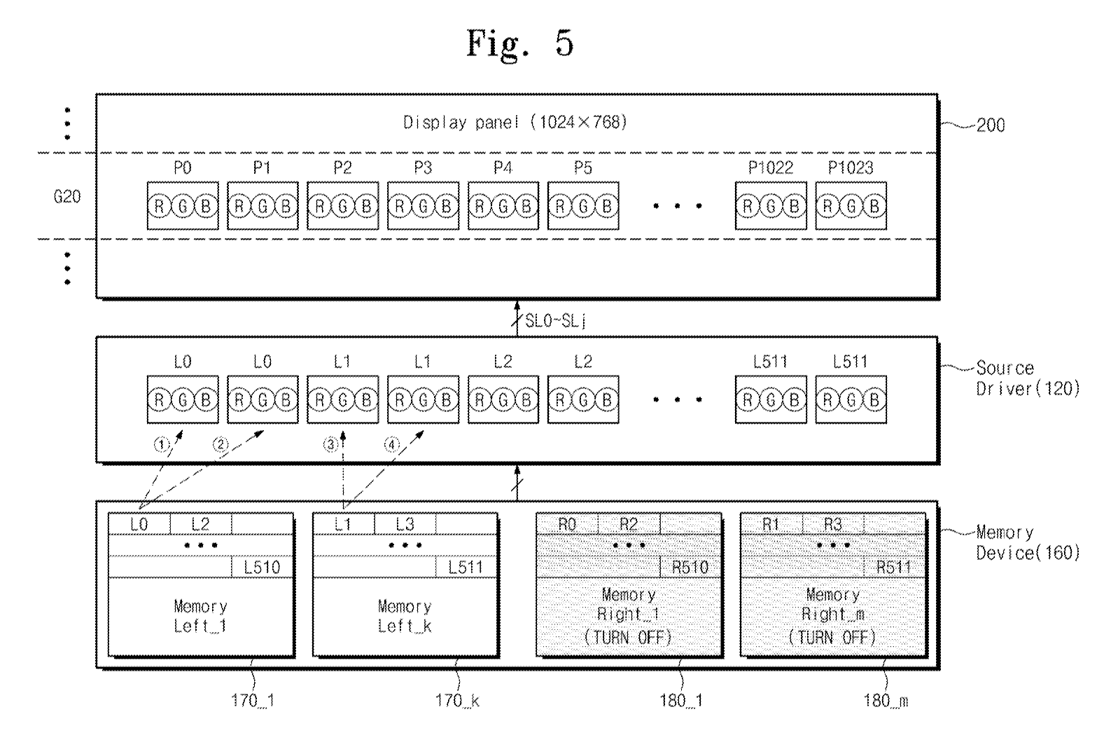

FIG. 5 is a diagram illustrating a 3D image data processing operation of a display driver integrated circuit according to an exemplary embodiment of the inventive concept in which 3D images are displayed as 2D images when in a power saving mode. Referring to FIG. 5, a display panel 200 may have a resolution of, for example 1024×768. Further, a memory device 160 may be formed of two left-eye image memory units 170_1 and 170_k and two right-eye image memory units 180_1 and 180_m. It should be understood, however, that the number of left-eye image memory units and the number of right-eye image memory units are not limited to the number provided in this disclosure and either fewer or additional memory units may be included.

As described below with respect to FIG. 4, left-eye image data L0 to L511 may be stored in the left-eye image memory units 170_1 and 170_k and right-eye image data R0 to R511 may be stored in the right-eye image memory units 180_1 and 180_m. This operation may be made under the control of a memory controller 150. The left-eye image data L0 to L511 may be stored alternately in the left-eye image memory units 170_1 and 170_k to reduce a time taken to store the left-eye image data L0 to L511 in the left-eye image memory units 170_1 and 170_k. For example, the left-eye image data L0 to L511 may be stored in the left-eye image memory units 170_1 and 170_k in an interleaving manner. Likewise, it is well understood that right-eye image data R0 to R511 are stored in right-eye image memory units 180_1 and 180_m in the same manner as the left-eye image data L0 to L511.

A central processing unit of a system may control a display driver integrated circuit 100 such that 3D image data is displayed by 2D image data. For example, to reduce power of the system, the central processing unit controls the display driver integrated circuit 100 such that 3D image data is displayed like 2D image data.

Where 3D images are displayed like 2D images while in a power saving mode, either left-eye image data L0 to L511 or right-eye image data R0 to R511 may be selected and read out under the control of the memory controller 150. In this case, selected image data may be read out in an interleaving manner to reduce time taken to output image data.

The image data thus selected and read may be provided to a source driver 120 sequentially. At this time, the selected and read image data may be provided to the source driver 120 such that the same image data is duplicated (for example, duplicated twice). This enables 2D images to be displayed on the display panel 200.

Where 3D images are displayed like 2D images in a power saving mode, as illustrated in FIG. 5, right-eye image memory units 180_1 and 180_m may be nonoperational and may be turned off to conserve power. For example, the right-eye image memory units 180_1 and 180_m are turned off to reduce power consumption. As another example, where 3D images are displayed like 2D images in a power saving mode, the left-eye image memory units 170_1 and 170_k may be turned off instead of the right-eye image memory units 180_1 and 180_m.

Right-eye image data R0 to R511 stored in the right-eye image memory units 180_1 and 180_m might not be provided to the source driver 120, accordingly, the left-eye image data L0 to L511 may be provided as a substitute for the right-eye image data R0 to R511. Accordingly, the left-eye image data L0 to L511 may be provided in duplicate. For example, left-eye image data L0 is read out from the left-eye image memory 170_1 and the read left-eye image data L0 is provided to the source driver 120 in duplicate. Then, left-eye image data L1 is read out from the left-eye image memory 170_k and the read left-eye image data L1 is provided to the source driver 120 in duplicate.

Latches (not shown) of the source driver 120 may temporarily store left-eye image data L0 to L511 provided to the source driver 120 according to the above-described manner. If image data (left-eye image data or right-eye image data) are received by the pixels connected with one gate line in the display panel 200, the source driver 120 provides the stored image data to the display panel 200 through source lines SL0 to SLj under the control of the timing controller 140. Where, for example, 1024 pixels are connected with one gate G20, 1024 units of image data (1024 duplicated left-eye image data) may be provided to the display panel 200.

The display driver integrated circuit 100 according to an exemplary embodiment of the inventive concept may operate while in a power saving mode under the control of the CPU of the system. In this case, the display driver integrated circuit 100 may control a memory device 160 such that 3D image data is displayed like 2D image data. Accordingly, power consumption of a system incorporating the display driver integrated circuit 100 may be reduced.

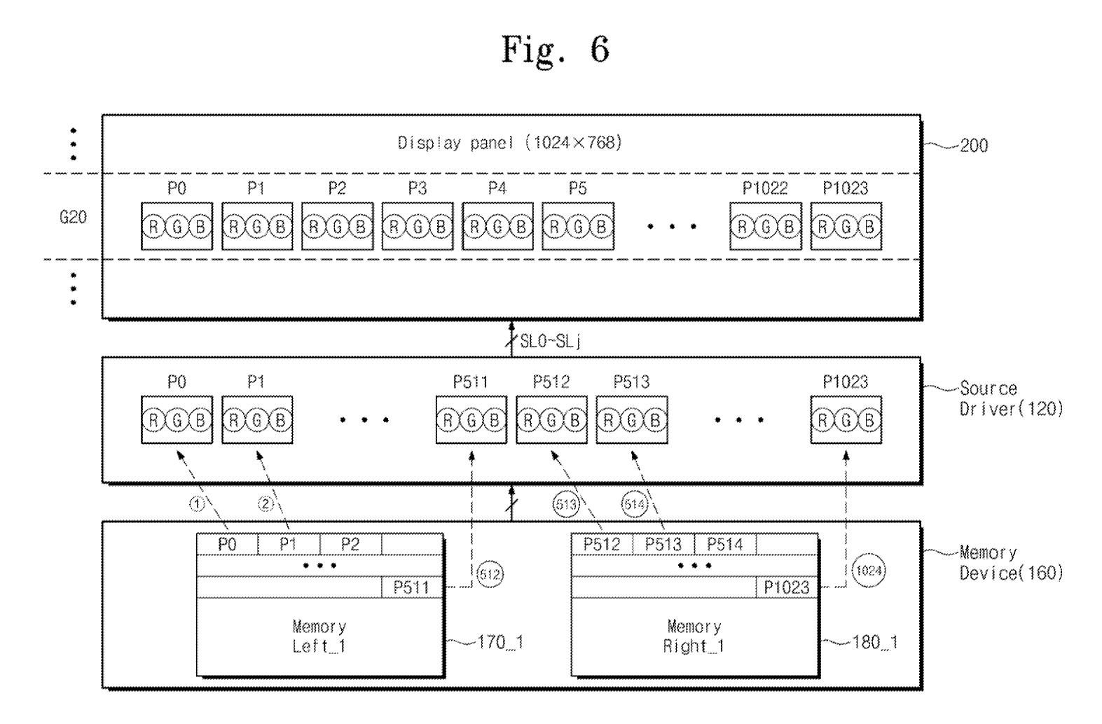

FIG. 6 is a diagram illustrating a 2D image data processing operation of a display driver integrated circuit according to an exemplary embodiment of the inventive concept. A display panel 200 may have a resolution of, for example, 1024×768. Further, a memory device 160 may include, for example, two memory units 170_1 and 180_1. The number of memory units in the memory device 160 is not limited to two and either fewer or more memory units may be included.

A display driver integrated circuit 100 may be configured to process 3D image data and 2D image data. For example, image signals provided from a central processing unit (CPU) of a system may be provided to a display panel 200 as 2D images. In this case, the CPU provides a control signal indicative of whether image signals provided to the display driver integrated circuit 100 are 3D image signals or 2D image signals.

Unlike 3D image data, 2D image data is not divided into left-eye image data and right-eye image data. Accordingly, where 2D image data is processed, the display driver integrated circuit 100 does not divide memory units in a memory device 160 into left-eye image memory units and right-eye image memory units.

2D image data P0 to P1023 may be sequentially stored in memory units 170_1 and 180_1 under the control of a memory controller 150. For example, the 2D image data P0 to P511 is stored in the memory 170_1 and the 2D image data P512 to P1023 is stored in the memory 180_1. The 2D image data P0 to P1023 may be stored alternately in the memory units 170_1 and 180_1 to reduce a time taken to store 2D image data. For example, the 2D image data P0 to P1023 may be stored in the memory units 170_1 and 180_{—} in an interleaving manner.

The 2D image data P0 to P 1023 stored in the memory device 160 may be read sequentially under the control of the memory controller 150. For example, 2D image data P0 to P11 ma be stored in the memory 170_1 and then 2D image data P512 to P1023 may be stored in the memory 180_1. Where 2D image data P0 to P1023 is stored in an interleaving manner, the 2D image data P0 to P1023 may be read in an interleaving manner.

The 2D image data P0 to P1023 read in the above-described manner may be provided sequentially to a source driver 120. Latches (not shown) of the source driver 120 may temporarily store the 2D image data P0 to P1023 provided to the source driver 120 according to the above-described manner. If image data (for example, 2D image data) are received by the pixels connected with one gate line in the display panel 200, the source driver 120 provides the stored image data to the display panel 200 through source lines SL0 to SLj under the control of the timing controller 140. For example, where 1024 pixels are connected with one gate G20, 1024 units of image data P0 to P1023 may be provided to the display panel 200.

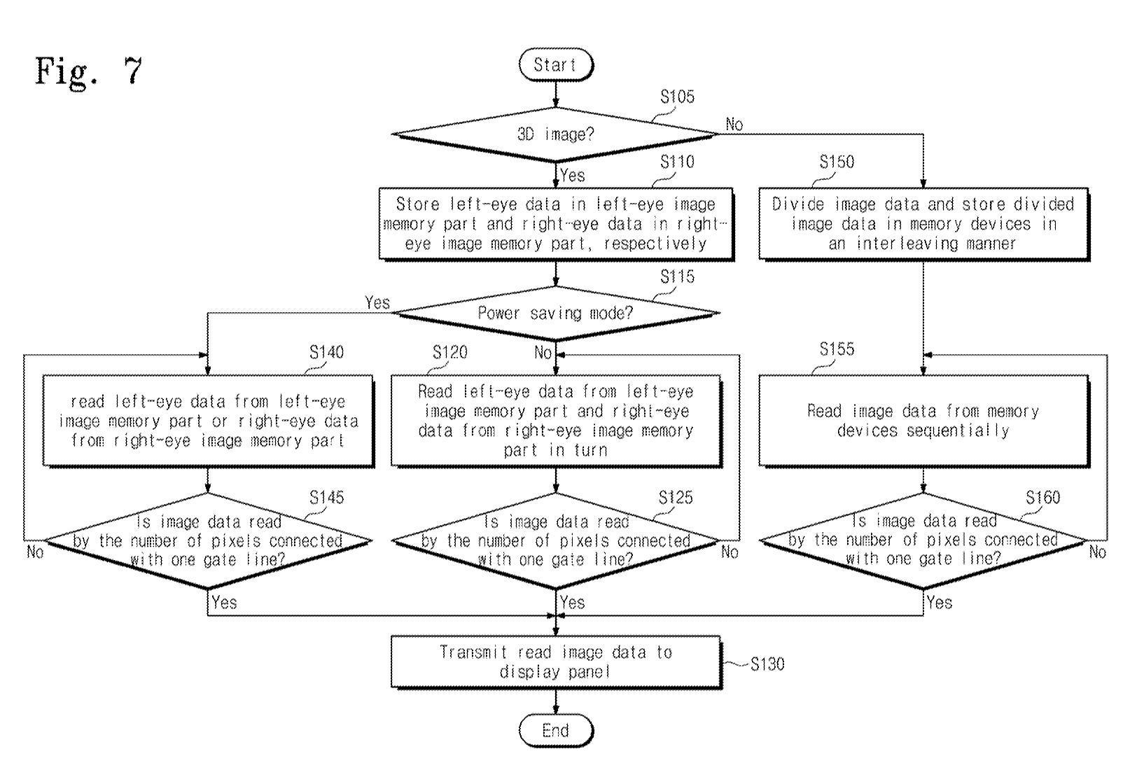

FIG. 7 is a flowchart illustrating an operation of a display driver integrated circuit according to an exemplary embodiment of the inventive concept. An operation of a display driver integrated circuit according to an exemplary embodiment of the inventive concept is described below with reference to FIG. 7.

A display driver integrated circuit 100 according to an exemplary embodiment of the present invention may operate differently according to a type of an image signal provided from a central processing unit (CPU) of a system. For example, the operation of the display driver integrated circuit 100 may depend upon whether an image signal provided from the CPU of the system is a 3D image signal or a 2D image signal (S105). According to an exemplary embodiment of the present invention, whether an image signal provided from the CPU of the system is a 3D image signal or a 2D image signal may be judged according to a control signal provided from the CPU of the system.

If an image signal provided from the CPU of the system is judged to be a 3D image signal, in step S110, the display driver integrated circuit 100 discriminates left-eye image data and right-eye image data included in the received 3D image signal. For example, left-eye image data is stored in a left-eye image memory part 170 and right-eye image data is stored in a right-eye image memory part 180. In this case, the left-eye image data may be stored in memory units 170_1 to 170_k in the left-eye image memory part 170 in an interleaving manner and the right-eye image data may be stored in memory units 180_1 to 180_m in the right-eye image memory part 180 in an interleaving manner.

The CPU provides a control signal to change a mode of operation of the display driver integrated circuit 100. For example, the CPU may provide a control signal such that the display driver integrated circuit 100 operates in a power saving mode. The power saving mode may be a mode of operation of the system in which power consumption is reduced. In step S115, the display driver integrated circuit 100 judges whether the control signal from the CPU indicates a power saving mode. If the control signal from the CPU does not indicate a power saving mode, the display driver integrated circuit 100 will process image data such that 3D images are displayed. This may be accomplished in steps S120, S125, and S130.

In step S120, the left-eye image data stored in the left-eye image memory part 170 and the right-eye image data stored in the right-eye image memory part 180 may be read alternately under the control of the memory controller 150. In this case, the left-eye image data may be read from memory units 170_1 to 170_k in the left-eye image memory part 170 in an interleaving manner and the right-eye image data may be read from memory units 180_1 to 180_m in the right-eye image memory part 180 in an interleaving manner.

The read left-eye and right-eye image data may be stored in latches of a source driver 120. At this time, the left-eye and right-eye image data may be stored so as to be disposed in turn. In step S125, it is judged whether left-eye and right-eye image data are read by the pixels connected with one gate line. If not, the operations S120 and S125 are repeated until left-eye and right-eye image data is read by the pixels connected with one gate line. If it is judged that the left-eye and right-eye image data are read by the pixels connected with one gate line, the method proceeds to step S130 in which the stored image data is transmitted to a display panel 200. As a result, the display panel 200 may display 3D image where left-eye and right-eye image data is disposed in turn.

Returning to step S115, if the control signal from the CPU indicates a power saving mode, the display driver integrated circuit 100 will process image data such that 3D images are displayed like 2D images. This may be made via steps S140, S145, and S130.

In step S140, either the left-eye image data stored in the left-eye image memory part 170 or the right-eye image data stored in the right-eye image memory part 180 may be read under the control of the memory controller 150. In this case, image data may be read in duplicate from the left-eye image memory part 170 or from the right-eye image memory part 180 but not from both.

The selectively read image data may be stored in latches of a source driver 120. In step S145, it is judged whether image data is read by the pixels connected with one gate line. If not, the operations S140 and S145 are repeated until image data is read by the pixels connected with one gate line. If it is judged that the image data is read by the pixels connected with one gate line, the method proceeds to step S130, in which the stored image data is transmitted to a display panel 200. As a result, the display panel 200 may display 2D image which is formed of left-eye or right-eye image data.

As described above, an operation of the display driver integrated circuit 100 may depend upon whether an image signal provided from the CPU of the system is a 3D image signal or a 2D image signal. If an image signal provided from the CPU of the system is not a 3D image signal, the display driver integrated circuit 100 may process 2D image data. This will be made in steps S150, S160, and S130.

If an image signal provided from the CPU of the system is a 2D image signal, in step S150, the display driver integrated circuit 100 stores image data of the 2D image signal in the memory device 160. Where the memory device 160 includes a plurality of memory units 170 and 180, the display driver integrated circuit 100 may divide the image data to store the divided image data in the memory units 170 and 180 in an interleaving manner, respectively.

In step S155, the 2D image data stored in the memory device 160 is sequentially read under the control of the memory controller 150. Where the image data is stored in the memory units 170 and 180 in an interleaving manner, the 2D image data may be read in the interleaving manner.

The read 2D image data may be stored in latches of the source driver 120. In step S160, it is judged whether image data is read by the pixels connected with one gate line. If not, the operations S155 and S160 are repeated until image data is read by the pixels connected with one gate line. If it is judged that the image data is read by the pixels connected with one gate line, the method proceeds to step S130, in which the stored image data is transmitted to a display panel 200. As a result, the display panel 200 may display 2D image which is formed of left-eye or right-eye image data, but not both.

The display driver integrated circuit 100 according to an exemplary embodiment of the inventive concept receives raw image signals from the CPU of the system. The display driver integrated circuit 100 generates 3D image data or 2D image data using an image signal according to a received image signal type and provides the image data thus generated to the display panel 200. Accordingly, the computational load placed on the CPU of the system and allocation of other resources may be reduced in displaying the image data. Therefore, an operating speed of the CPU is increased and system resources are used efficiently.

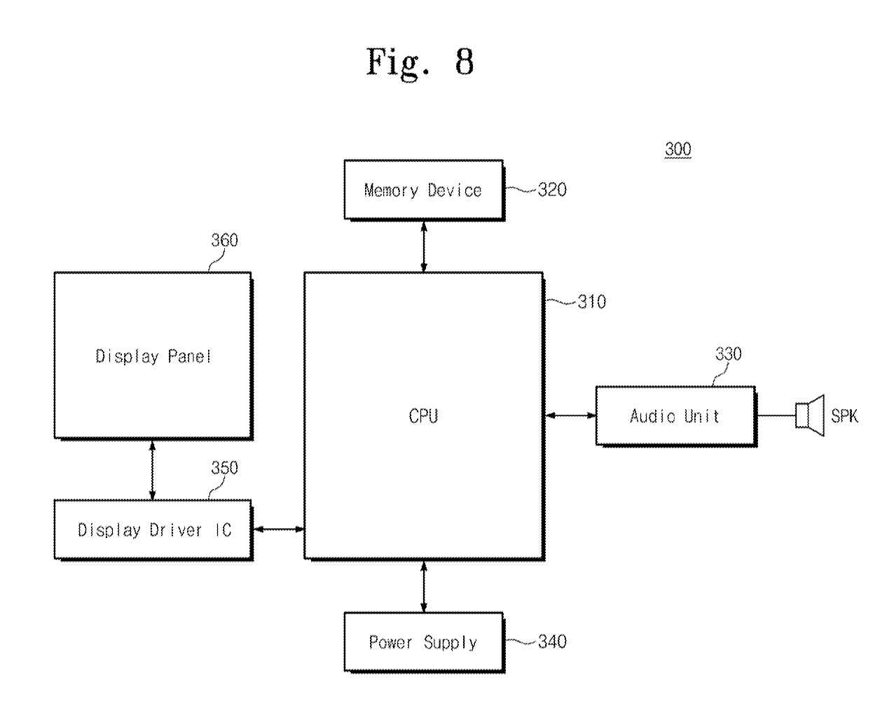

FIG. 8 is a block diagram showing a user device for displaying images via a display panel according to an exemplary embodiment of the inventive concept. Referring to FIG. 8, a user device 300 displaying images via a display panel is illustrated. The user device 300 may be, for example, a mobile electronic device 300. The mobile electronic device 300 includes a central processing unit (CPU) 310, a memory device 320, an audio unit 330, a power supply 340, a display driver IC 350, and a display panel 360.

The CPU 310 may control an overall operation of the mobile electronic device 300. For example, at power-up, the CPU 310 may control a booting operation of the mobile electronic device 300. Further, the CPU 310 may activate each element according to setting of a user. The CPU 310 may be configured to drive firmware for controlling the mobile electronic device 300. The firmware may be loaded onto a work memory of the memory device 320, and the CPU 310 executes the firmware loaded on the work memory.

The memory device 320 may include a volatile memory device such as

DRAM and a non-volatile memory device such as ROM, a flash memory device, or the like. Data necessary for driving of the mobile electronic device 300 is stored in the memory device 320. For example, the operating system and application programs necessary for driving of the mobile electronic device 300 are stored in the memory device 320. Further, the operating system and the application programs may be loaded on a volatile memory device in the memory device 320 under the control of the CPU 310.

The audio unit 330 includes a speaker SPK. The audio unit 330 may reproduce audio data under the control of the CPU 310. The power supply 340 supplies power necessary for driving the mobile electronic device 300. The power supply 340 may include a battery where the mobile electronic device 300 is of a small-sized suitable for being easily carried.

The display driver integrated circuit 350 receives raw image signals from the CPU 310. The display driver integrated circuit 350 generates image data (3D image data or 2D image data) corresponding to the received image signals according to an image signal type. The display driver integrated circuit 350 provides the image data to the display panel 360 so as to be displayed.

Although not illustrated in FIG. 8, the mobile electronic device 300 may further include a radio frequency part which receives and transmits various types of data, audio signals, and image signal. The mobile electronic device 300 may further include an input part which receives a control signal of a user.

With exemplary embodiments of the inventive concept, the CPU 310 may reduce processing and resource allocation for displaying 3D images or 2D images. Therefore, an operating speed of the CPU 310 is increased, and system resources are used efficiently.

The above-disclosed subject matter is to be considered illustrative, and not restrictive.

What is claimed is:

1. A display driver integrated circuit of driving a display panel, comprising:
a source driver driving one or more source lines of the display panel;
a plurality of memory devices storing image data to be displayed by the display panel;
a memory controller controlling a write operation or a read operation of the plurality of memory devices; and
a timing controller controlling the memory controller such that the image data stored in the plurality of memory devices are generated as three-dimensional (3D) image data and controlling the source driver such that the generated 3D image data is provided to the display panel.

2. The display driver integrated circuit of claim 1, wherein the plurality of memory devices stores left-eye image data and right-eye image data.

3. The display driver integrated circuit of claim 2, wherein the plurality of memory devices includes at least one memory unit for storing the left-eye image data at least one memory unit for storing the right-eye image data.

4. The display driver integrated circuit of claim 3, wherein the memory controller controls the plurality of memory units for storing the left-eye image data and the plurality of memory units for storing the right-eye image data

5. The display driver integrated circuit of claim 3, wherein the memory controller controls the plurality of memory devices such that the left-eye image data and the right-eye image data are read in turn.

6. The display driver integrated circuit of claim 5, wherein the timing controller controls the source driver such that the read left-eye image data and the read right-eye image data are alternately disposed and temporarily stored in latches.

7. The display driver integrated circuit of claim 2, wherein when the display driver integrated circuit is controlled to operate while in a power saving mode, the timing controller controls the memory controller and the source driver such that the left-eye image data and the right-eye image data stored in the plurality of memory devices are reproduced as 2D image data and controls the source driver such that the generated 2D image data is provided to the display panel.

8. The display driver integrated circuit of claim 1, further comprising a gate driver driving gate lines of the display panel.

9. A method for operating a display driver integrated circuit for driving a display panel, the method comprising:
storing image data to be displayed by the display panel in a plurality of memory devices that includes at least one left-eye memory device for storing left-eye image data and at least one right-eye memory device for storing right-eye image data, the at least one left-eye memory device being different than the at least one right-eye memory device;
reading left-eye image data from the at least one left-eye memory device of the plurality of memory devices;
reading right-eye image data from the at least one right-eye memory device of the plurality of memory devices;
temporarily storing the read left-eye and right-eye image data in a source driver so that the left-eye image data and the right-eye image data are available for simultaneous display; and
providing the temporarily stored 3D image data to the display panel.

10. The operating method of claim 9, wherein the at least one left-eye memory device includes a first plurality of memory units and the at least one right-eye memory device includes a second plurality of memory units.

11. The operating method of claim 10, wherein the storing of the left-eye image data and the storing of the right-eye image data are performed by alternating between the storing of the left-eye image data within each of the first plurality of memory units and by alternating between the storing of the right-eye image data within each of the second plurality of memory units.

12. The operating method of claim 10, further comprising:
reading image data from either the stored left-eye image data or the stored right-eye image data when the display driver integrated circuit is operating in a power saving mode; and
transmitting the read image data to a source driver in duplicate to be stored temporarily in the source driver.

13. The operating method of claim 9, wherein the reading of the plurality of memory devices is performed in an interleaving manner.

14. The operating method of claim 9, wherein the storing of the image data to be displayed by the display panel in the plurality of memory devices includes storing the 2D image data in the plurality of memory devices sequentially when the image data to be displayed by the display panel is 2D image data.

15. The operating method of claim 14, wherein the storing of the image data to be displayed by the display panel in a plurality of memory devices is performed in an interleaving manner.

16. An autostereoscopic display device, comprising:
a display panel having either a parallax barrier or a lenticular lens in proximity thereto;
a gate driver driving a plurality of gate lines of the display panel;
a source driver driving a plurality of source lines of the display panel; and
a memory device for storing an image signal to be displayed on the display panel,
wherein the memory device includes a left-eye image memory part for storing left-eye image data of the image signal and a right-eye image memory part for storing right-eye image data of the image signal, the left-eye image memory part being different than the right-eye image memory part,
wherein the left-eye image memory part comprises a plurality of distinct left-eye memory units and the right-eye image memory part comprises a plurality of distinct right-eye memory units, and
wherein the left-eye image data is stored by alternating between each of the plurality of left-eye memory units and the right-eye image data is stored by alternating between each of the plurality of right-eye memory units.

17. The autostereoscopic display device of claim 16, wherein when the image signal is a 3D image signal, the left-eye image data is read by alternating between each of the plurality of left-eye memory units and the right-eye image data is read by alternating between each of the plurality of memory units, the read image data is temporarily stored in the source driver for simultaneous display of the left-eye image data and the right-eye image data, and the temporarily stored left-eye image data and the right-eye image data are displayed on the display panel as a series of columns or stripes in which every other column or stripe is a portion of the left-eye image data and every other column or stripe is a portion of the right-eye image data.

18. The autostereoscopic display device of claim 16, wherein when the autostereoscopic display device enters a power saving mode, either the left-eye image data is read by alternating between the plurality of left-eye memory units or the right-eye image data is read by alternating between the plurality of right-eye memory units, and whichever image data is read is stored in duplicate in the source driver and displayed as a 2D image on the display panel.

19. The autostereoscopic display device of claim 18, wherein the autostereoscopic display device enters the power saving mode when the image data is determined to be 2D image data.

20. The autostereoscopic display device of claim 18, wherein when the autostereoscopic display device enters a power saving mode, either the left-eye image memory part or the right-eye image memory part is deactivated depending upon whether the left-eye image data is read or the right-eye image data is read.
